(19) United States
(12) Patent Application Publication
(10) Pub. No.: US 2007/0028457 A1
(43) Pub. Date: Feb. 8, 2007

(54) Hairdressing scissors

(76) Inventor: Wen-Ya Yeh, Tainan City (TW)

Correspondence Address: PRO-TECHTOR INTERNATIONAL SERVICES, 20775 NORADA CT., SARATOGA, CA, 95070, US

(21) Appl. No.: 11/195,192

(22) Filed: Aug. 2, 2005

(51) Int. Cl. B26B 13/00

(52) U.S. Cl. 30/226

(57) ABSTRACT

A pair of scissors comprises a first blade, a second blade pivotally secured to the first blade, at least a recess formed at least one of the first and second blades, in the recess disposed a pin, and at least a retainer pivotally secured to at least one of the first and second blades and having a hook. In this way, two pairs of scissors can be secured to each other in such a manner that a retainer of a first one of the two pairs of scissors is locked in a recess of a second one of the two pairs of scissors and a hook of the retainer of the first one of the two pairs of scissors is secured to a pin of the second one of the two pairs of scissors.

### BACKGROUND OF THE INVENTION

1. Field of the Invention

The present invention relates to a pair of hairdressing scissors and the connecting device thereof, and more particularly to a pair of hairdressing scissors having connecting device formed on the handle portion thereof, so that plural pairs of such hairdressing scissors can be detachably secured to one another.

2. Description of the Prior Arts

A hairstylist cuts a customer's hair with several techniques, including trimming, thinning, layering, etc. Sometimes the hairstylist has to hold plural pairs of scissors in the same hand for proceeding with the thinning or layering of the hair to obtain the desired special hairstyle.

During operation of the plural pairs of scissors in the same hand, the user must keep the plural pairs of scissors be spaced at regular intervals and operate them with the same operating condition. The plural pairs of scissors must open and close synchronously to obtain a tidy, beautiful hairstyle. However, the plural pairs of scissors are simply held by fingers of the user such that the plural pairs of scissors cannot be operated synchronously due to touchy control of the plural pairs of scissors by the fingers. Thus, the plural pairs of scissors often become skew to one another and the spacing therebetween may be different from one another. The haircutting result is adversely affected, and this problem is aggravated if the user is inexperienced. The user often feels pain when operating the plural pairs of scissors in addition to numerous limitations to and difficulties in operation.

U.S. Pat. Nos. 6,192,590 B1, 6,434,833 B1 and 6,634,106 B2 disclose hairdressing scissor assemblies to solve the above-mentioned problems. These hairdressing scissor assemblies can be detachably engaged together so as to allow the hairstylist to use them as freely and easily as using one hairdressing scissor assembly.

The present invention has arisen to mitigate and/or obviate the afore-described disadvantages.

### SUMMARY OF THE INVENTION

The primary objective of the present invention is to provide a pair of hairdressing scissors having connecting device formed on the handle portion thereof, so that plural pairs of such hairdressing scissors can be detachably secured to one another.

A pair of scissors and connecting device thereof comprising:

a first blade;

a second blade pivotally secured to the first blade;

at least a recess formed at least one of the first and second blades, in the recess disposed a pin; and

at least a retainer pivotally secured to at least one of the first and second blades and having a hook, two pairs of scissors are secured to each other in such a manner that a retainer of a first one of the two pairs of scissors is locked in a recess of a second one of the two pairs of scissors and a hook of the retainer of the first one of the two pairs of scissors is secured to a pin of the second one of the two pairs of scissors.

In the recess can be formed a protrusion, so that a retainer of a first one of the two pairs of scissors is locked in a recess of a second one of the two pairs of scissors and a hook of the retainer of the first one of the two pairs of scissors is secured to a protrusion of the second one of the two pairs of scissors.

A cavity is formed on an outer lateral surface of at least one of the first and second blades, the retainer has a sheet-like body and is provided at either side thereof with a connecting portion that is to be inserted in the cavity, and the pivot is inserted the connecting portion and the cavity.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a pair of hairdressing scissors in accordance with a first embodiment of the present invention, and also shows an amplified view of a part of a handle portion;

FIG. 2 is an enlarged view of showing a part of the right handle portion of the scissors in FIG. 1 where the retainer is mounted;

FIG. 3 shows that three pairs of scissors are coupled together;

FIG. 4 is a cross sectional view of a part of the scissors of FIG. 3;

FIG. 5 is a cross sectional view of FIG. 3 taken along the line 5-5;

FIG. 6 is a perspective view of a pair of hairdressing scissors in accordance with the second embodiment of the present invention, and also shows an amplified view of a part of a handle portion;

FIG. 7 is an enlarged view of showing a part of the right handle portion of the scissors in FIG. 6 where the retainer is mounted;

FIG. 8 shows that three pairs of scissors are coupled together;

FIG. 9 shows that three pairs of scissors are piled up together;

FIG. 10 is a cross sectional view of FIG. 8 taken along the line 10-10;

FIG. 11 is a perspective view of a pair of hairdressing scissors in accordance with the third embodiment of the present invention, and which also shows an amplified view of a part of a handle portion;

FIG. 12 is an enlarged view of showing a part of the right handle portion of the scissors in FIG. 11 where the retainer is mounted;

FIG. 13 shows that three pairs of scissors are piled up together;

FIG. 14 is a cross sectional view of showing the respective pairs of scissors before being connected; and

FIG. 15 is a cross sectional view of FIG. 13 taken along the line 15-15.

### DETAILED DESCRIPTION OF THE PREFERRED EMBODIMENTS

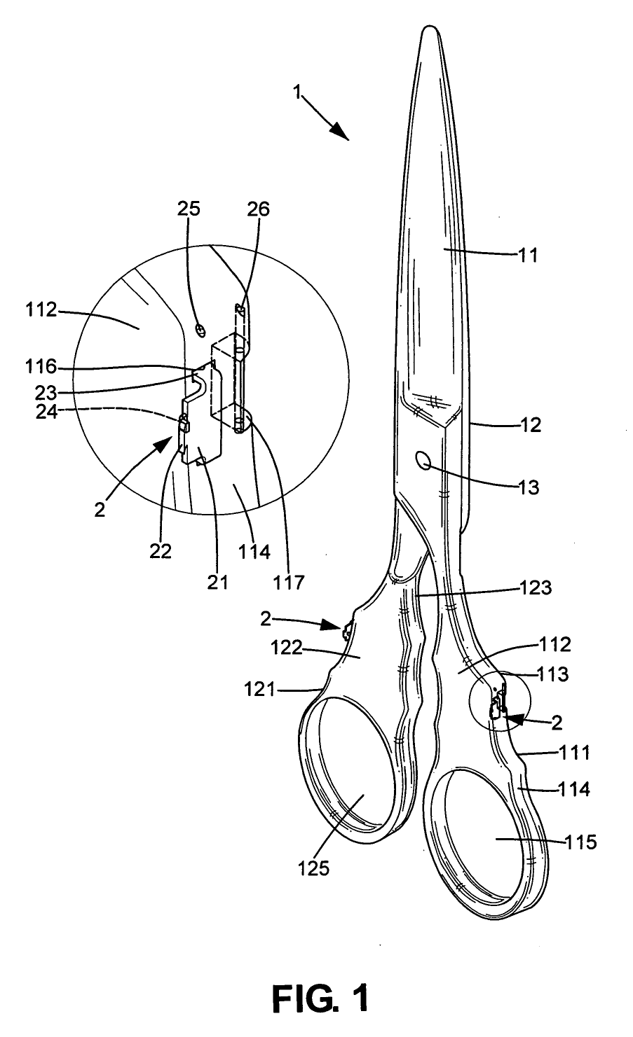

FIG. 1 is a perspective view of a pair of hairdressing scissors in accordance with a first embodiment of the present invention, and also shows an amplified view of a part of a handle portion 111. The pair of hairdressing scissors 1 includes a first blade 11 and a second blade 12. The end of the first and second blades 11 and 12 are connected handle portions 111, 121 each having an opening 115 and 125 for fingers of the user. The first and second blades 11, 12 are pivotally connected through a pivot 13.

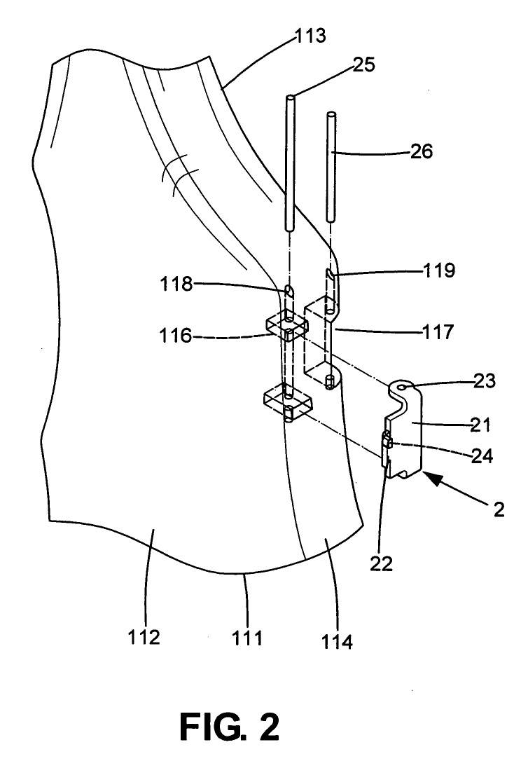

As shown in FIGS. 1 and 2, FIG. 2 is an amplified view of showing a part of the right handle portion of the scissors in FIG. 1 where the retainer is mounted, the handle portions 111, 121 each includes a first side 112 and 122, a second side 113 and 123, and an outer lateral surface 114 and 124 located between the first side and the second side.

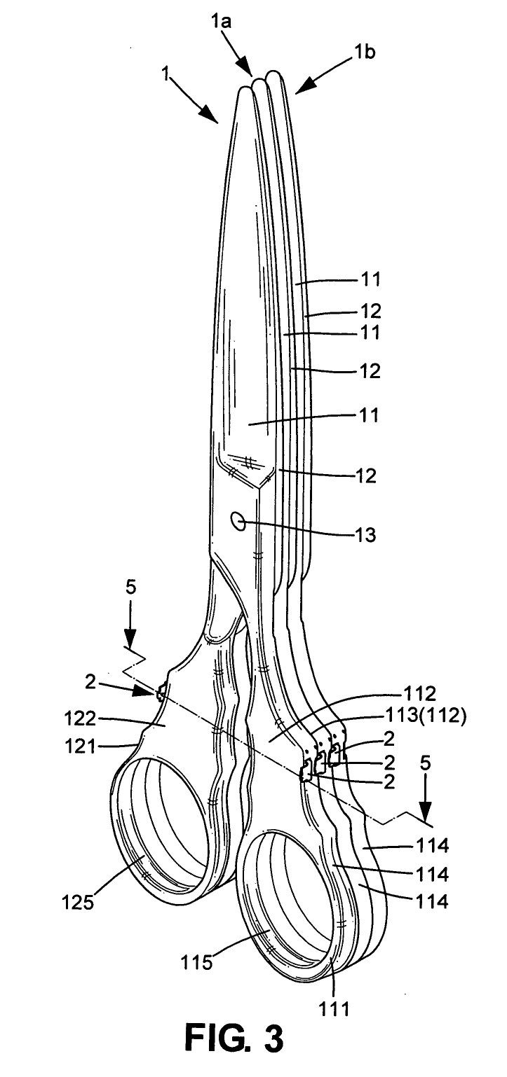

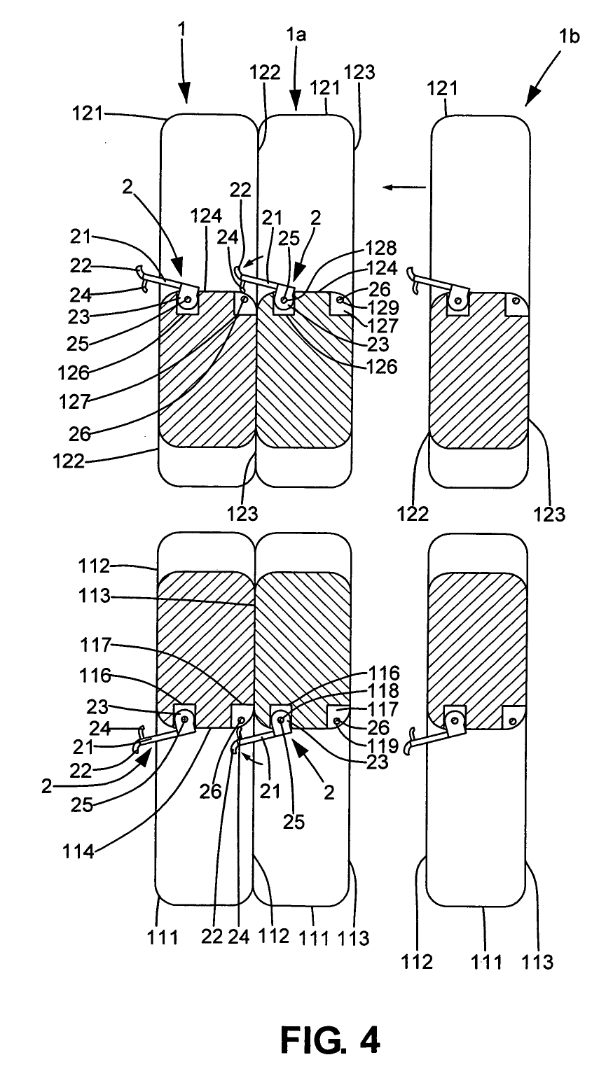

Referring to FIGS. 1-4, FIG. 3 shows that three pairs of scissors are coupled together, and FIG. 4 is a cross sectional view of a part of the scissors of FIG. 3. The characteristic of this embodiment is that on the outer lateral surfaces 114 and 124 of the pair of scissors 1 is provided at least a retainer 2 for retaining another a pair of scissors. With this method, a plurality of pairs of scissors can be detachably locked together.

In accordance with a first embodiment of the present invention, at least two cavities 116 and 126 are formed on the outer lateral surface 114 and 124 of the handle portion 111 and 121. The retainer 2 has a sheet-like body 21 and is provided at the front end thereof with a protrusion 22. On a side of the body 21 facing the outer lateral surfaces 114 and 124 is formed a hook 24, and on either side of a rear end of the body 21 is formed a connecting portion 23 that is vertical to the body 21 and employed to insert in the cavities 116 and 126. On the outer lateral surfaces 114 and 124 is formed holes 118 and 128 through which a pivot 25 is inserted into the cavities 116 and 126 after passing through the connecting portion 23, so that the securing the retainer 2 is pivotally secured to the pivot 25 and received in the cavities 116 and 126.

On the outer lateral surface 114 and 124 is further defined a recess 117 and 127 located adjacent to the secured retainer 2. In this embodiment, the recess 117 and 127 is arranged between the outer lateral surface 114 and the second side 113, and a hole 119, 129 is formed for allowing a pin 26 to transversely insert in the recess 117 and 127.

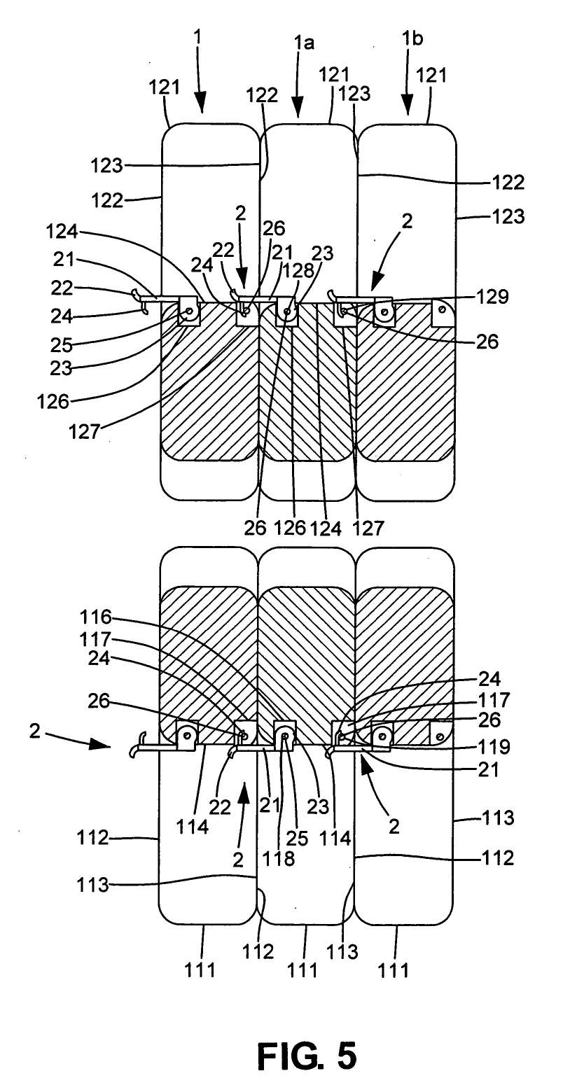

With reference to FIGS. 3-5, FIG. 5 is a cross sectional view of FIG. 3 taken along the line 5-5, the scissors are detachably coupled together by the following steps: firstly, abutting the first sides 112 and 122 of the pair of scissors 1a against the second sides 113 and 123 of the pair of scissors 1 in such a manner that the retainers 2 of the scissors 1a are aligned with the recesses 117 and 127 of the scissors 1. And then pressing the hooks 24 of the retainers 2 onto the pins 26, in this way, a plurality of pairs of scissors can be fastened one another. And the respective pairs of scissors can be released easily by pulling the retainers 2 away from the pins 26.

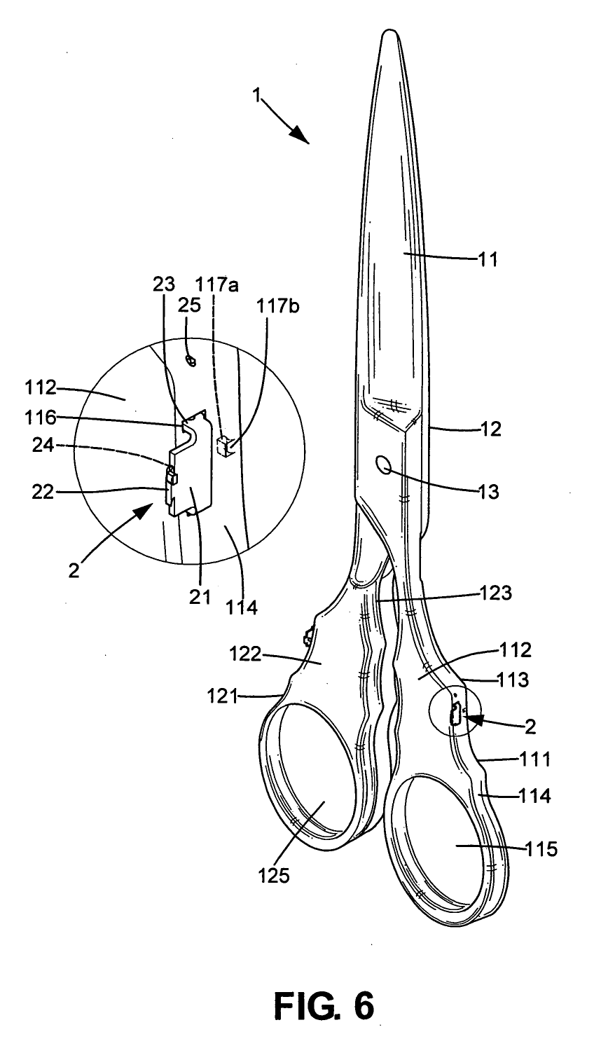

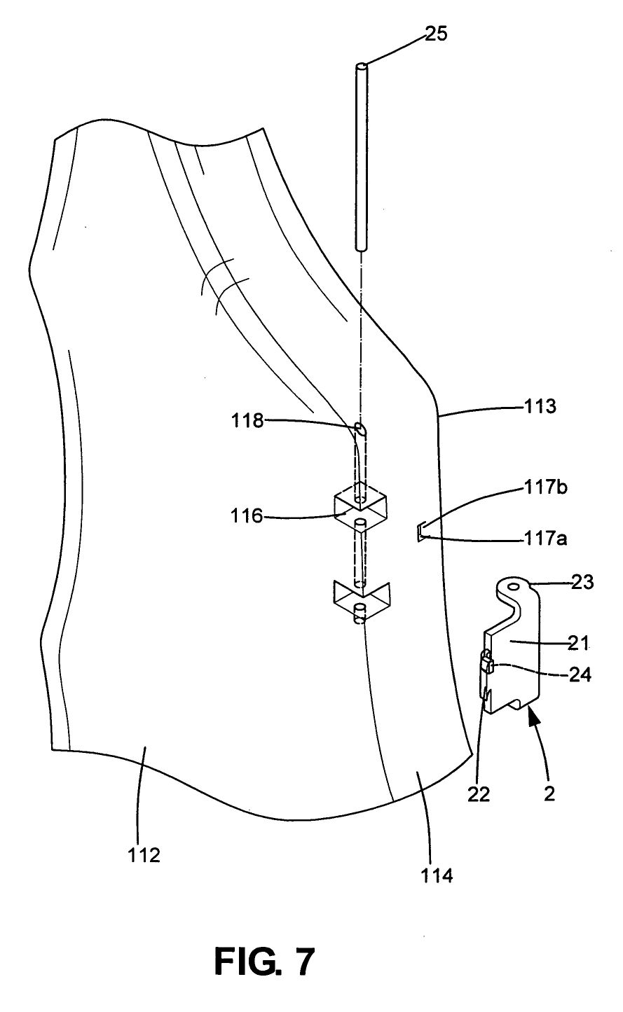

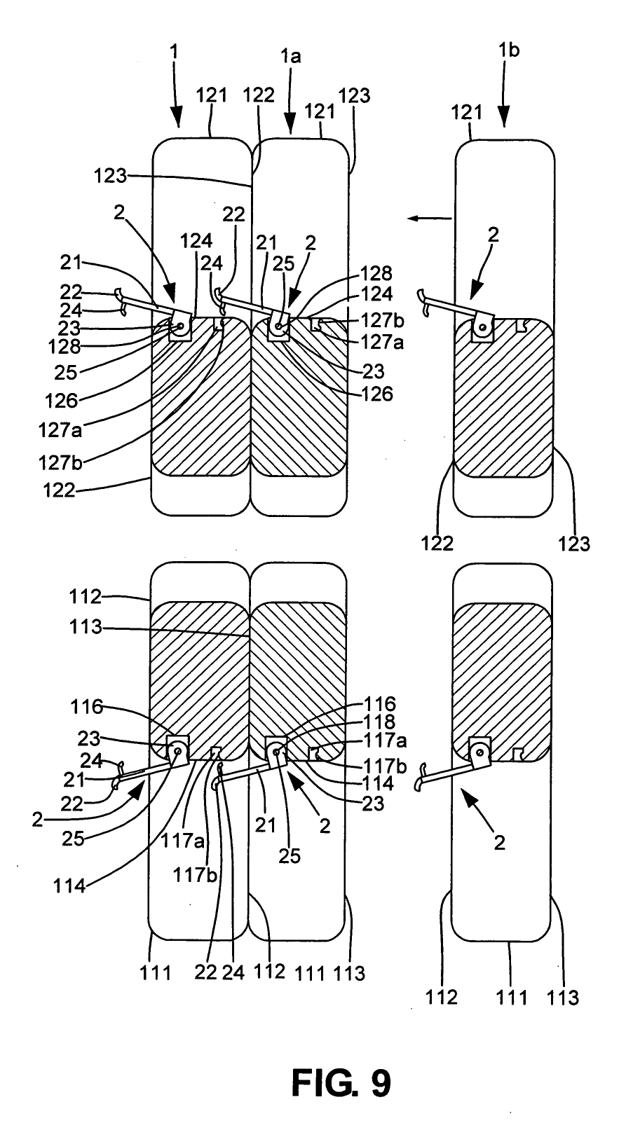

Referring further to FIGS. 6-9, which show a connecting structure for a pair of hairdressing scissors in accordance with a second embodiment of the present invention (components in this embodiment identical or equivalent to the first embodiment are indicated by the same reference number). FIG. 6 is a perspective view of a pair of hairdressing scissors in accordance with the second embodiment of the present invention, and also shows an amplified view of a part of a handle portion 111. FIG. 7 is an amplified view of a part of the right handle portion of the scissors in FIG. 6 where the retainer is mounted. FIG. 9 shows that three pairs of scissors are piled up together. In this embodiment, the retainers 2 are also pivotally fixed to the outer lateral surfaces 114 and 124 of the handle portions 111 and 121. And on the outer lateral surfaces 114 and 124 is defined a recess 117a and 127a in which is formed a protrusion 117b and 127b for retaining the hook 24 of the retainers 2.

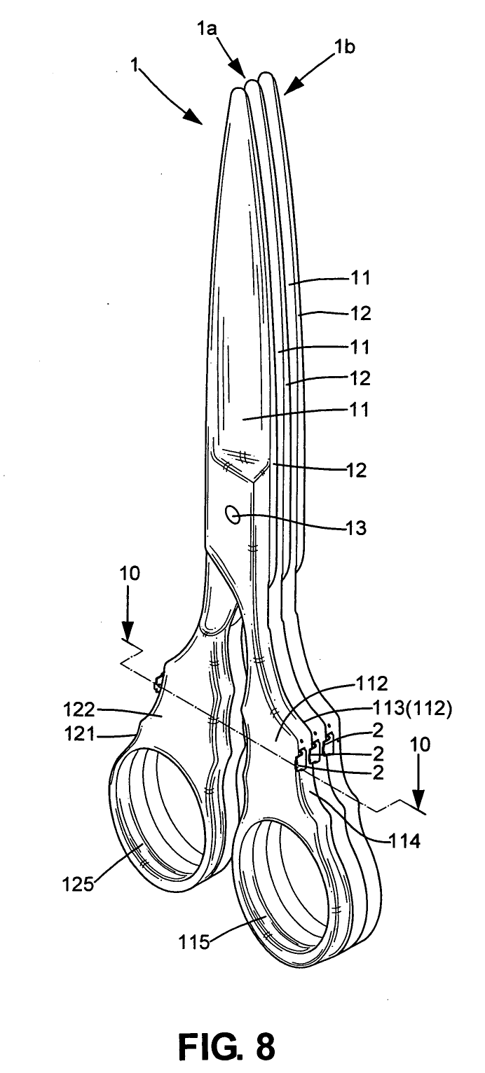

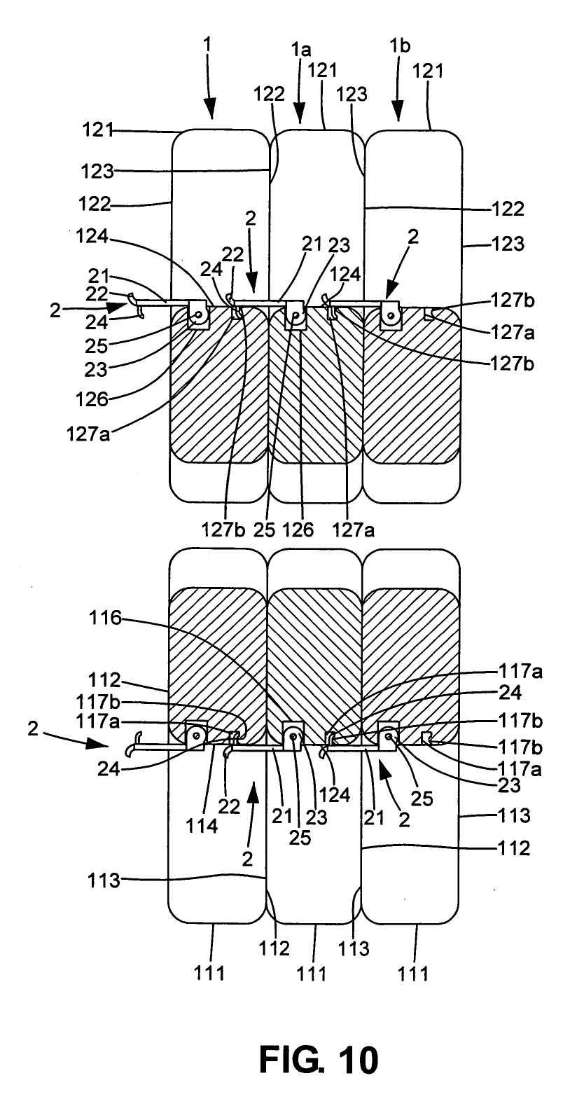

With references to FIGS. 8 and 9, the scissors are detachably coupled together by the following steps: firstly, abutting the first sides 112 and 122 of the pair of scissors 1a against the second sides 113 and 123 of the pair of scissors 1 in such a manner that the retainers 2 of the scissors 1a are aligned with the recesses 117a and 127a of the scissors 1. And then pressing the hooks 24 of the retainers 2 onto the protrusions 117b and 127b inside the recesses 117a and 127a, in this way, a plurality of pairs of scissors can be fastened together, as shown in FIG. 10. And the respective pairs of scissors can be released easily by pulling the retainers 2 away from the protrusions 117b and 127b.

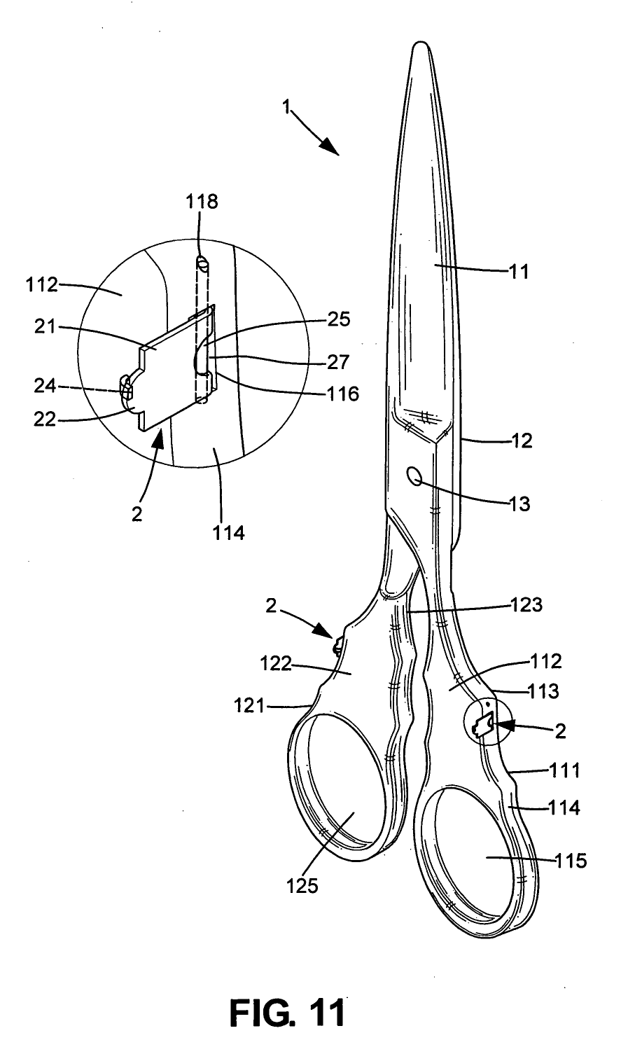

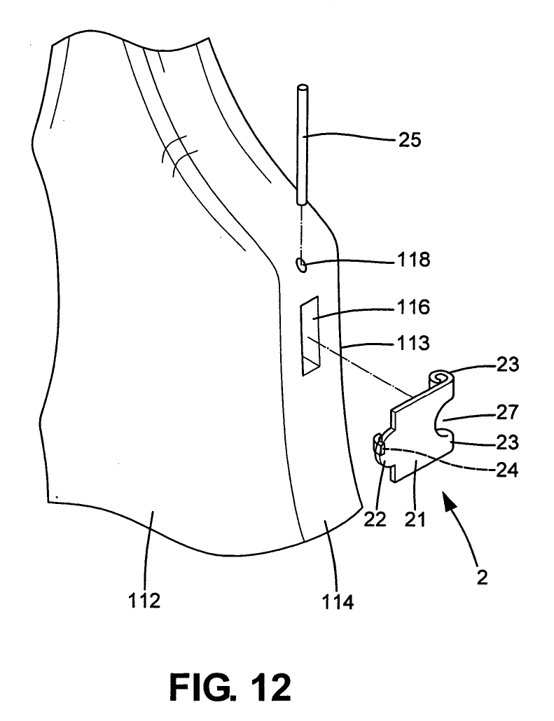

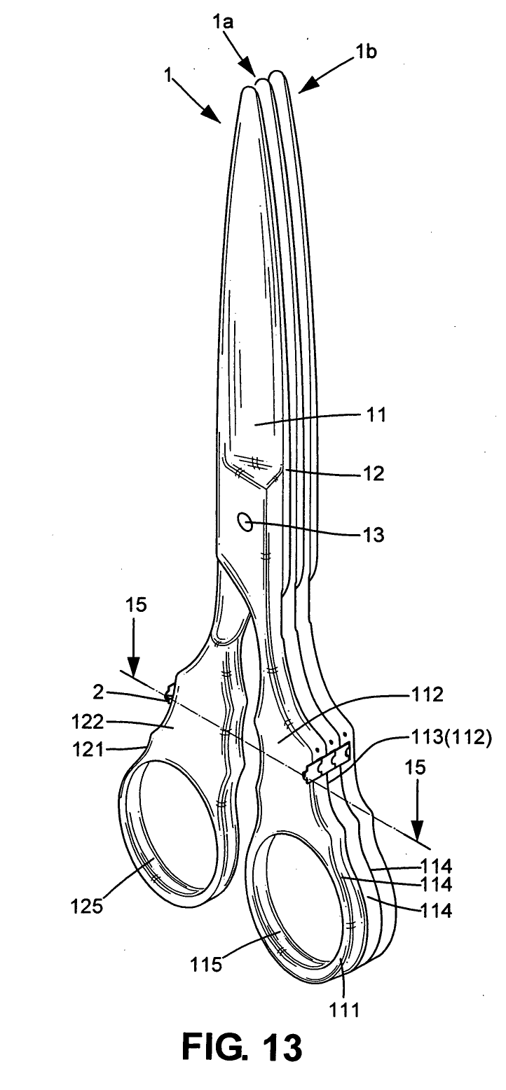

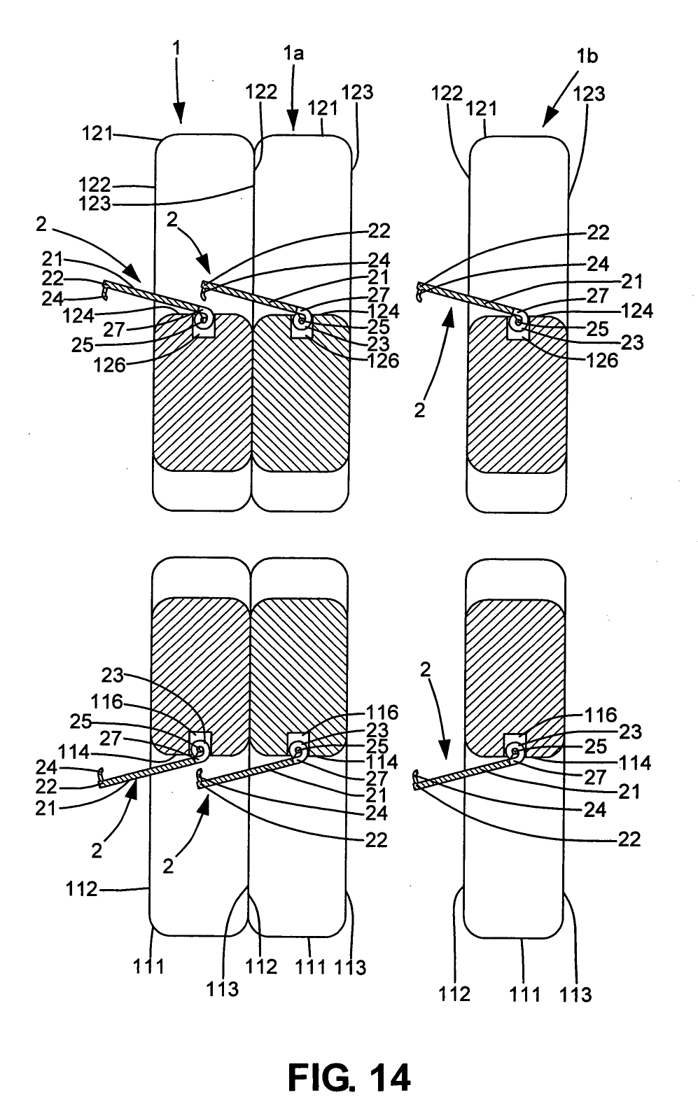

Referring further to FIGS. 11-14, which show a connecting structure for a pair of hairdressing scissors in accordance with a third embodiment of the present invention (components in this embodiment identical or equivalent to the first embodiment are indicated by the same reference number). FIG. 11 is a perspective view of a pair of hairdressing scissors in accordance with the third embodiment of the present invention, and which also shows an amplified view of a part of a handle portion 111. FIG. 12 is an amplified view of showing a part of the right handle portion of the scissors in FIG. 11 where the retainer is mounted. FIG. 13 shows that three pairs of scissors are piled up together. FIG. 14 is a cross sectional view of showing the respective pairs of scissors before being connected.

In this embodiment, the retainers 2 are also pivotally fixed to the outer lateral surfaces 114 and 124 of the handle portions 111 and 121. And on the outer lateral surfaces 114 and 124 is defined at least a cavity 116 and 126 in which is pivotally disposed a retainer 2. The retainer 2 has a sheet-like body 21, at a side of the retainer 2 is provided a protrusion 22, while at another opposite side of the retainer 2 is formed a notch 27 for mating with the protrusion 22 (the notch 27 is formed correspondingly to the shape of the protrusion 22). The sheet-like body 21 at either side of the notch 27 is folded into two coaxial tube-like connecting portions 23. On the outer lateral surfaces 114 and 124 is formed holes 118 and 128 through which a pivot 25 is inserted into the cavities 116 and 126 after passing through the holes 118 and 128 and the connecting portions 23, so that the securing the retainer 2 is pivotally secured to the outer lateral surfaces 114 and 124, and the pivot 25 inserted in the connecting portions 23 is partially exposed in the notch 27.

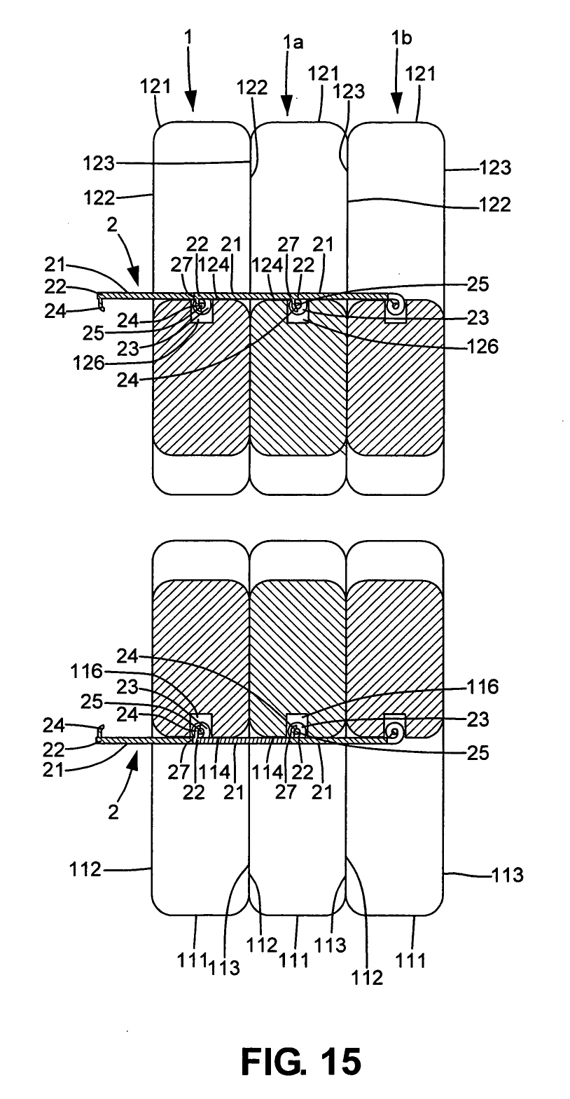

Referring to FIGS. 13-15, the scissors are detachably coupled together by the following steps: firstly, abutting the first sides 112 and 122 of the pair of scissors 1a against the second sides 113 and 123 of the pair of scissors 1 in such a manner that the retainers 2 of the scissors 1a are aligned with the notch 27 of the retainer 2 of the scissors 1. And then pressing the hooks 24 of the retainers 2 onto the pivot 25 and the protrusion 22 of the retainer 2 of the scissors 1a will be mated with the notch 27 of the retainer 2 of the scissors 1. In this way, a plurality of pairs of scissors can be fastened one another.

While we have shown and described various embodiments in accordance with the present invention, it should be clear to those skilled in the art that further embodiments may be made without departing from the scope of the present invention.

What is claimed is:

1. A pair of scissors comprising:
a first blade;
a second blade pivotally secured to the first blade;
at least a recess formed at least one of the first and second blades, in the recess disposed a pin; and
at least a retainer pivotally secured to at least one of the first and second blades and having a hook, two pairs of scissors are secured to each other in such a manner that a retainer of a first one of the two pairs of scissors is locked in a recess of a second one of the two pairs of scissors and a hook of the retainer of the first one of the two pairs of scissors is secured to a pin of the second one of the two pairs of scissors.

2. The pair of scissors as claimed in claim 1, wherein two cavities are formed on an outer lateral surface of at least one of the first and second blades, the retainer has a sheet-like body and is provided at either side thereof with a connecting portion that is to be inserted in the two cavities, and a pivot is inserted the connecting portion and the cavities.

3. The pair of scissors as claimed in claim 2, wherein the recess is formed on the outer lateral surface of at least one of the first and second blades.

4. The pair of scissors as claimed in claim 1, wherein the retainer further includes a protrusion.

5. A pair of scissors comprising:
a first blade;
a second blade pivotally secured to the first blade;
at least a recess formed at least one of the first and second blades, in the recess being formed a protrusion; and
at least a retainer pivotally secured to at least one of the first and second blades and having a hook, two pairs of scissors are secured to each other in such a manner that a retainer of a first one of the two pairs of scissors is locked in a recess of a second one of the two pairs of scissors and a hook of the retainer of the first one of the two pairs of scissors is secured to a protrusion of the second one of the two pairs of scissors.

6. The pair of scissors as claimed in claim 5, wherein two cavities are formed on an outer lateral surface of at least one of the first and second blades, the retainer has a sheet-like body and is provided at either side thereof with a connecting portion that is to be inserted in the two cavities, a pivot is inserted the connecting portion and the cavities, and the retainer is pivotally secured to an outer lateral surface of at least one of the first and second blades.

7. The pair of scissors as claimed in claim 6, wherein the recess is formed on the outer lateral surface of at least one of the first and second blades.

8. The pair of scissors as claimed in claim 5, wherein the retainer further includes a protrusion.

9. A pair of scissors comprising:
a first blade;
a second blade pivotally secured to the first blade;
at least a retainer pivotally secured to at least one of the first and second blades and having a hook, and
at least a pivot secured to at least one of the first and second blades and serving to pivotally fix the retainer, two pairs of scissors are secured to each other in such a manner that a hook of retainer of a first one of the two pairs of scissors is secured to a pivot of a second one of the two pairs of scissors.

10. The pair of scissors as claimed in claim 9, wherein a cavity is formed on an outer lateral surface of at least one of the first and second blades, the retainer has a sheet-like body and is provided at either side thereof with a connecting portion that is to be inserted in the cavity, and the pivot is inserted the connecting portion and the cavity.

11. The pair of scissors as claimed in claim 9, wherein the retainer is further defined with a notch and the pivot is partially exposed in the notch.

12. The pair of scissors as claimed in claim 11, wherein the retainer is further provided with a protrusion that is located opposite the notch.

13. The pair of scissors as claimed in claim 12, wherein the protrusion is shaped correspondingly to the notch.
